(19) United States
(12) Patent Application Publication
(10) Pub. No.: US 2024/0188508 A1
(43) Pub. Date: Jun. 13, 2024

(54) SYSTEMS AND METHODS FOR INVERSE LIGHTING OF A PLANT

(71) Applicant: Stem Cultivation, Inc., Woburn, MA (US)

(72) Inventors: Kyle W. Moffitt, Woburn, MA (US); Robert Priore, Waltham, MA (US)

(73) Assignee: Stem Cultivation, Inc., Woburn, MA (US)

(21) Appl. No.: 18/536,598

(22) Filed: Dec. 12, 2023

Related U.S. Application Data
(60) Provisional application No. 63/432,271, filed on Dec. 13, 2022.

(51) Int. Cl. A01G 9/02; A01G 9/24

(52) U.S. Cl. CPC A01G 9/023; A01G 9/247; A01G 9/249

(57) ABSTRACT

Systems and methods for cultivating a plant are disclosed, including an inverse lighting system in which photosynthetic energy sources, such as lamps or lights, are placed under or behind the plants such that the light is directed away from the structure housing the plant. Photosynthetic energy sources are disposed behind or under the canopy of the plant to direct energy away from the structure in which the plant is growing.

### CROSS-REFERENCE TO RELATED APPLICATIONS

This application claims priority to U.S. Provisional Patent Application No. 63/432,271, filed on Dec. 13, 2022, the content of which is hereby incorporated by reference in its entirety.

### FIELD OF TECHNOLOGY

The described technology generally relates to plant cultivation, and more particularly to an inverse lighting system for vertical plant growing and cultivation.

### BACKGROUND

It is estimated that over 50% of U.S. households actively garden at home or as members of community gardens. In particular, younger growers (so-called Gen-Z and Millennials) have become the fastest-growing demographic segment to participate in personal food and plant cultivation since the COVID-19 pandemic. People grow and maintain home gardens for many reasons, but for most growers, maintaining control of their food source is a primary driver.

Most store-bought fruits and vegetables in the U.S. are grown on large farms concentrated in a few geographic regions having ideal weather and other environmental conditions for outdoor growing, depending on the particular crop type. Modern industrial farmers commonly use pesticides, herbicides, or gene-editing to optimize plants' survivability in suboptimal environmental conditions and retain the crops retail value as they move across large supply chains. These additional steps, however, can negatively affect the tastes, flavors and health of fresh food and contribute to many home gardeners' distrust of commercial food production. The reduced availability and quality of seasonal plant varietals during the winter and spring further exacerbates frustrations and infeasibility of large-crop plants.

Home gardeners face several challenges preventing achievement of personal food independence, including short outdoor growing seasons, limited gardening space, and a lack of cost-effective options for indoor gardening. One challenge in particular is providing effective and consistent lighting to promote plant growth. Traditional methods direct light toward the tops of the plant canopy. While this vertical configuration improves traditional horizontal configurations by allowing more canopy area and higher production yields in the same floor space. Vertically grown plants may often compete for light energy and room to grow. Further, the space between the light source and plant canopy remains underutilized.

### SUMMARY

Aspects of the present disclosure relate to concepts, techniques systems and methods for providing energy, such as light, to a plant to promote the growth and cultivation of a plant consistently and effectively. Aspects of the present disclosure provide for an inverse lighting system in which photosynthetic energy sources, such as lamps or lights, are placed under or “behind” the plants (relative to an observer) such that the light is directed away from the structure housing the plant.

According to one aspect, a multi-plant holder may include a structure defining a plurality of holders adapted to retain a plurality of plants and a light source disposed adjacent to the structure. The light source may be adapted to provide a positive phototropic force on the plurality of plants towards the structure.

The multi-plant holder may include one or more of the following features alone or in combination. The light source may be adapted to emit energy away from the structure. Each of the plurality of holders may be aligned vertically in the structure. The structure may be a tower. The tower may define a central column in fluid communication with the plurality of holders. The structure may comprise a plurality of towers, each of the plurality of towers defining a vertical arrangement of holders. The light source may be adapted to provide the positive phototropic force towards a top portion of the structure. The plurality of holders may be defined on one or more sides of a structure with a rectilinear cross-section, or positioned radially around a structure with a circular cross-section. The light source may be coupled to one or more sides of a structure with a rectilinear cross-section, or positioned radially around a structure with a circular cross-section. The structure may be in fluid communication with an irrigation system adapted to supply a nutrient to the plurality of holders.

According to another aspect, a method of cultivating a plant may include disposing a plurality of plants into a plurality of holders defined in a structure and disposing a light source adjacent to the structure. The light source may be adapted to provide a positive phototropic force on the plurality of plants towards the structure.

The method of cultivating a plant may include one or more of the following features alone or in combination. The light source may be adapted to emit energy away from the structure. Each of the plurality of holders may be aligned vertically in the structure. The structure may be a tower. The tower may define a central column in fluid communication with the plurality of holders. The structure may comprise a plurality of towers, each of the plurality of towers defining a vertical arrangement of holders. The light source may be adapted to provide the positive phototropic force towards a top portion of the structure. The plurality of holders may be defined on one or more side(s) of the structure. The light source may be coupled to one or more side(s) of the structure.

According to another aspect, a multi-plant holder may include a structure having a first side and second side. Each side may define a plurality of vertically spaced holders and each of the holders may define a recess adapted to receive a plant. A first light source may be adjacent to the first side and a second light source adjacent to the second side. The first light source and the second light source may be adapted to provide a positive phototropic force towards the structure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1A is a front view of a multi-column vertical plant growing configuration.

FIG. 1B is a side view of a multi-column vertical plant growing configuration.

FIG. 1C is an isometric view of a multi-column vertical plant growing configuration.

FIG. 2A is a front view of a multi-column vertical plant growing configuration, according to aspects of the present disclosure.

FIG. 2B is a side view of a multi-column vertical plant growing configuration, according to aspects of the present disclosure.

FIG. 2C is an isometric view of a multi-column vertical plant growing configuration, according to aspects of the present disclosure.

FIG. 3A is a side view of a portion of a vertical plant growing structure.

FIG. 3B is a side view of a portion of a vertical plant growing structure, according to certain aspects of the disclosure.

FIG. 4A is a diagram of plant growth.

FIG. 4B is a diagram of plant growth, according to certain aspects of the disclosure.

FIG. 5A is a side view of a lighting portion of a vertical plant growing structure.

FIG. 5B is a side view of a lighting portion of a vertical plant growing structure, according to certain aspects of the disclosure.

FIG. 6A is a diagram of vertical plant growth.

FIG. 6B is a diagram of vertical plant growth according to certain aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. It will be apparent to those skilled in the art, however, that these concepts may be practiced without these specific details. In some instances, well-known structures and components are shown in block diagram form in order to avoid obscuring such concepts.

The described technology generally relates to plant cultivation and, more particularly, to concepts and techniques for improving the efficiency, cost-effectiveness, and yield of a cultivation system. Vertical growing systems, like those described in U.S. Pat. No. 11,089,744, entitled, “Cultivation Systems and Methods,” the content of which is hereby incorporated by reference in its entirety, use vertically spaced plant holders fluidically connected to an irrigation system to maximize the grow-area and yield of one or more growing plants. Light sources, such as lamps or the like, are needed to provide a photosynthetic energy source to stimulate and support plant growth.

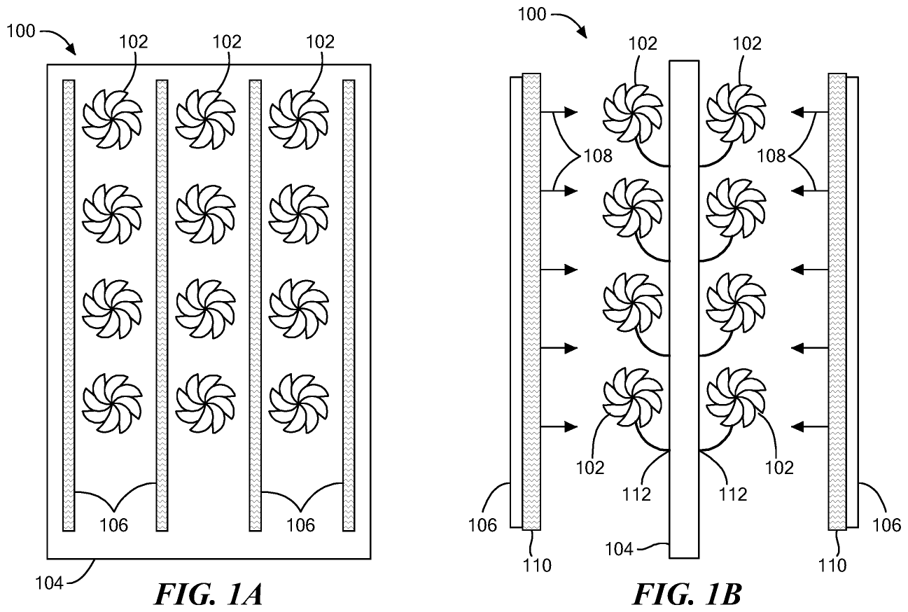

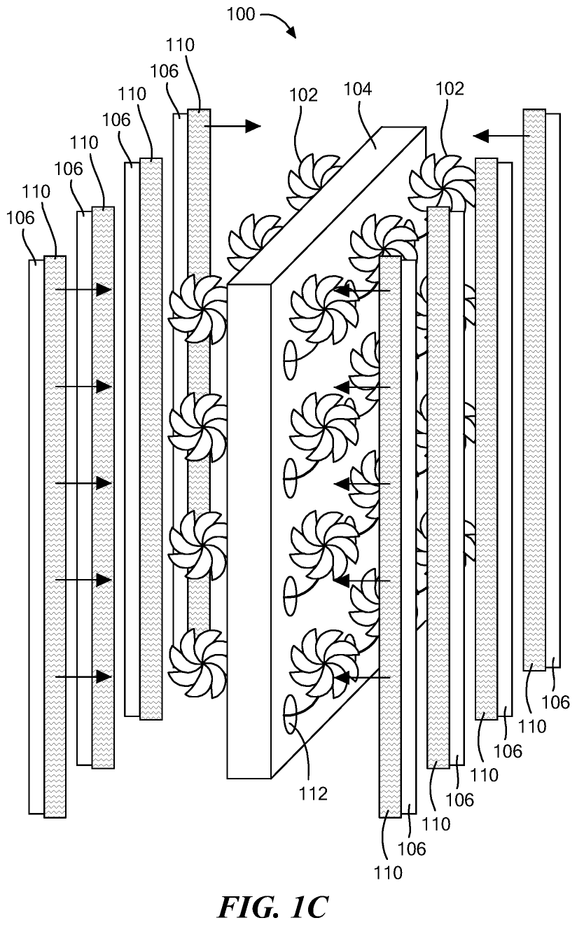

Referring to FIGS. 1A-1C, a cultivation system 100 for growing a plurality of plants 102 may include a structure 104 including or defining a number of plant holders 112. The structure 104 may be single- or dual-sided depending on the system configuration. The structure 104 may be fluidically coupled to an irrigation system (not shown) used to feed the plants 102 nutrients, including water, to promote growth. One or more light sources 106 may be disposed at a distance from the structure 104 such that light energy 110 is directed towards outer canopy of the plants 102 (shown by arrows 108). The light source 106 may include LED lamps, incandescent or fluorescent lamps, infrared lamps, or other suitable photosynthetic energy source.

While this vertical configuration of the system 100 may improve traditional horizontal configurations by allowing more canopy area and higher production yields in the same floor space, plants may be forced to compete for light and grow space, and the space between the light source and plant canopy remains underutilized compared to the proposed configuration.

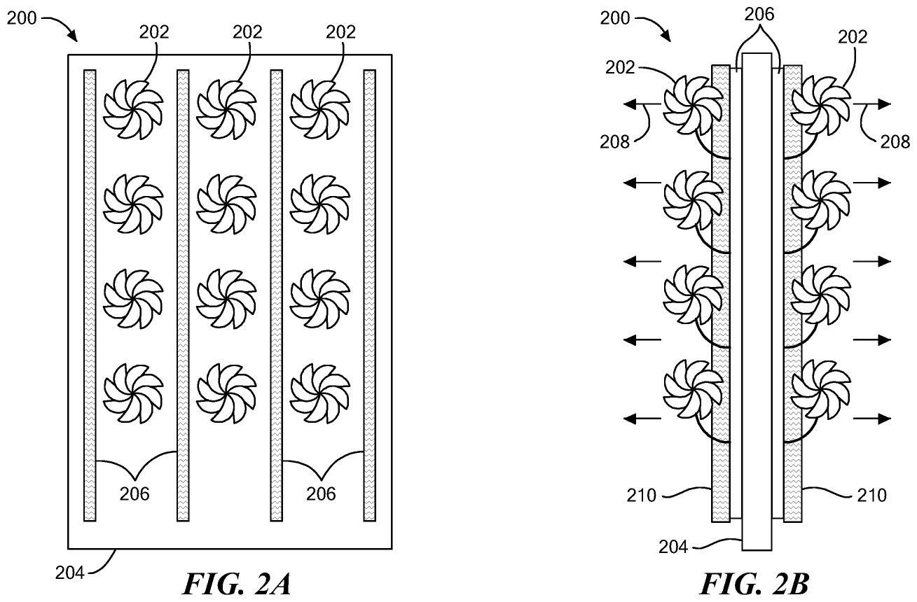

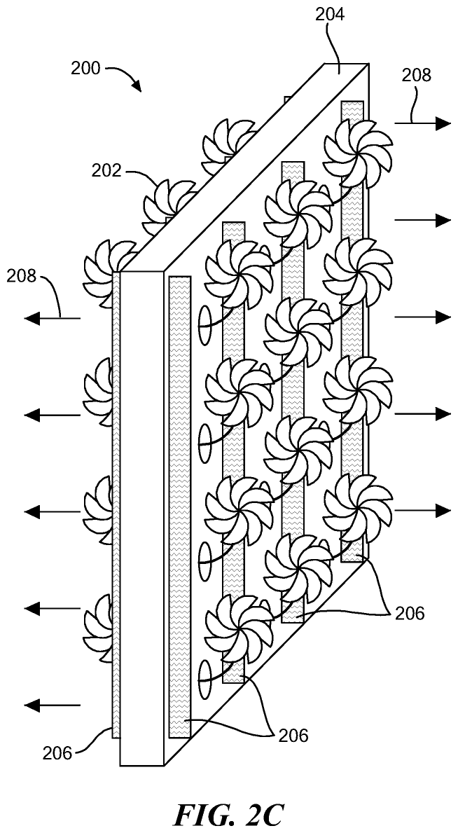

Turning now to FIGS. 2A-2C, a cultivation system 200 having an inverse lighting configuration is shown. The system 200 may include a structure 204 adapted to hold or house a plurality of plants 202. The structure may be formed from or include a one or more towers, columns, or other structures in which the plants 202 may be vertically arranged. The structure 204 may also be adapted to house or hold the plant 202 on opposing sides so that the number of plants 202 housed in the structure 204 may be increased, for example doubling the number of plants 202. One or more light sources 206 may be disposed adjacent to, or coupled to, the structure 204 such that light 210 may be transmitted towards the plants 102 and away from the structure 204 (shown as arrows 208). The light source 206 may include LED lamps, incandescent or fluorescent lamps, infrared lamps, or other suitable photosynthetic energy source. According to one aspect, the light sources 206 may be coupled directly to the structure 204 or may be coupled to another assembly adjacent to the structure 204.

As shown in the side-view of FIG. 2B and the isometric view of FIG. 2C, as the plants 202 begin to grow, light sources 206 may be adapted to transmit light from “behind” the plants (relative to the observer) 102, lighting the canopy formed by the bodies, leaves and other sections. As described herein, lighting the plant canopy from behind, or the backside, exposes more of the surface area of the plants to the photosynthetic energy emitted by the light sources 206 (“front,” “backside,” or “behind” are descriptions of the plant orientation in a vertical configuration relative to the observer; however, the photosynthetic process is the same irrespective of the plant's orientation relative to the source of radiation). The inverse lighting system may increase even light distribution across all plants 202 from behind the canopy as each plant is the closest it can be to the light source 206 and equally exposed to the same intensity as its neighbor This is in comparison to the known methods, where a plant may outcompete and block its neighbor's exposure to the light in ‘front’ of the plant and can cause more uneven production across the canopy.

According to one or more aspects of the present disclosure, the cultivation system 200 configured with the inverse lighting system provides numerous technical and practical advantages over conventional lighting configurations. For example, and described below, the inverse lighting system may increase the canopy area and yield production of a plant crop in the same amount of floor space compared to the known methods. The inverse lighting system may also reduce or eliminate additional supports or assemblies to augment the plant's structural integrity (e.g., trellis netting) by inducing a growth pattern that naturally creates a more stable center of mass that allows larger plant structure and more production. The system may also reduce the range between the lights and the plant canopy, which allows plants to absorb similar or greater photosynthetic active radiation (PAR) using less energy than the known methods by exploiting the inverse square relationship between light intensity and distance.

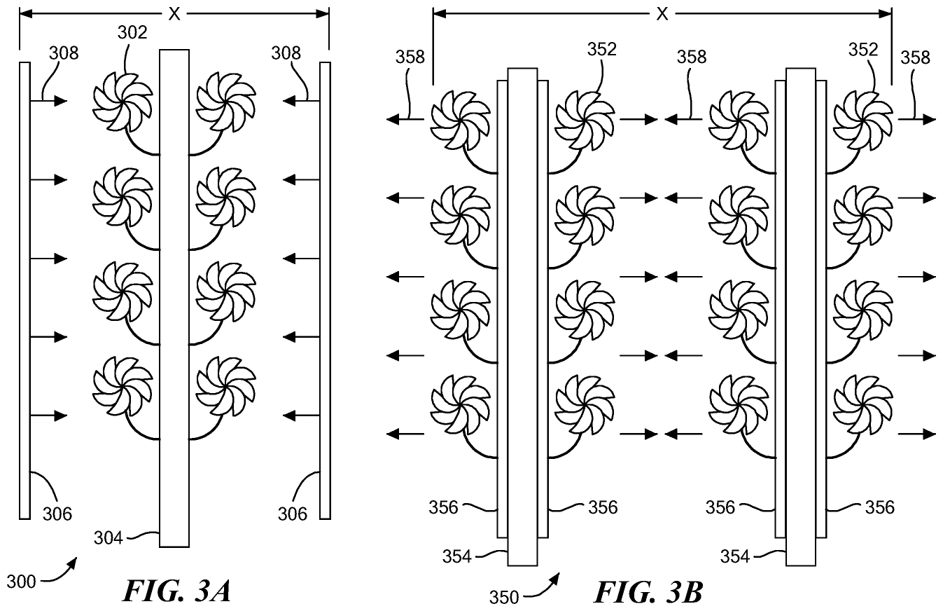

As mentioned above, the inverse lighting system may allow for an increased canopy area and yield production for a given amount of grow space. Referring now to FIGS. 3A-3B, a known lighting configuration may be compared to aspects of the inverse lighting system according to aspects of the disclosure. FIG. 3A depicts a side view of a conventional lighting configuration 300 in which the light sources 306 are placed a distance away from a dual-sided structure 304 and transmit light 308 towards the “fronts” of the plurality of plants 302. The light source 306 may include LED lamps, incandescent or fluorescent lamps, infrared lamps, or other suitable photosynthetic energy source.

The conventional configuration requires a minimum spacing between the canopy of plants 302 and the light sources 306 mounted directly in front of the structure 304 to account for canopy expansion as it grows. The total width of the dual-sided configuration 300, including the light sources 306, plants 302, and structure 304 may denoted by the span ‘x’.

As shown in FIG. 3B, an inverse lighting configuration 350 may include one or more structures 354, each one dual-sided, housing a plurality of plants 352 and including one or more light sources 356. In the inverse lighting configuration, the light sources 356 may be coupled to or disposed adjacent to the structures 354, transmitting light 358 away from the respective structures 354 and lighting the plants 352 from behind. The light source 356 may include LED lamps, incandescent or fluorescent lamps, infrared lamps, or other suitable photosynthetic energy source.

Advantageously, the inverse lighting configuration 300 allows for twice the number of plants 352 and structures 354 in the same amount of space, span ‘x’, as the conventional configuration 300 of FIG. 3A. The inverse lighting configuration 300 may integrate the light sources into the structure 354 (or adjacent thereto) and may eliminate the minimum spacing requirement for outward canopy expansion. This may allow a denser array of vertical planter structures, like structure 354, and higher production per square foot of floor space without affecting the canopy's light exposure.

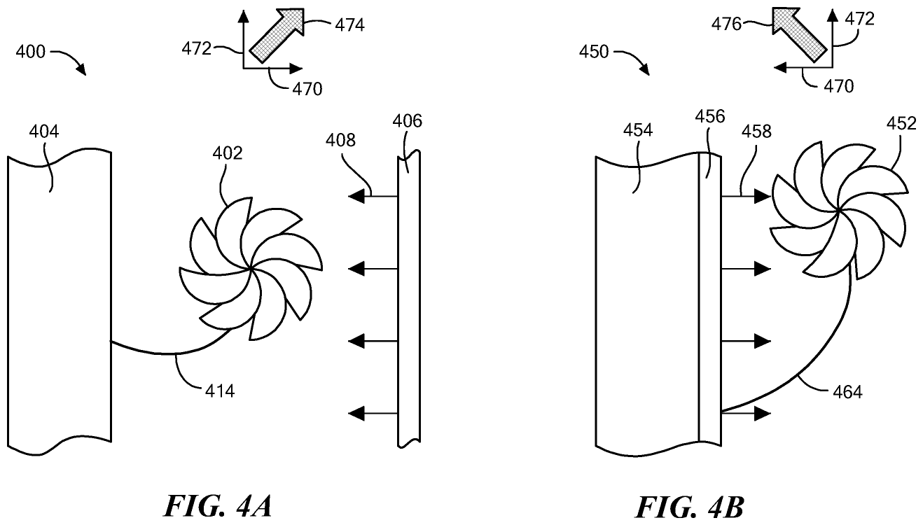

FIGS. 4A-4B show a comparison of plant growth in a conventional lighting configuration 400 (FIG. 4A) versus that of an inverse lighting configuration 450 (FIG. 4B). According to conventional methods, a plant 402 housed in a vertical planter, such as structure 404, may receive light 408 from a light source 406 disposed a minimum distance from the structure 404. The light source 406 may include LED lamps, incandescent or fluorescent lamps, infrared lamps, or other suitable photosynthetic energy source. The plant 402, supported by its stem 414, in this configuration may grow outward from the structure (i.e. toward the light source 406) and upward. This may be due to phototropism and gravitropism.

Phototropism may be considered the growth response of a plant 402 in response to the light 408. Positive phototropism occurs when a plant grows in the direction of the light source. Gravitropism in plants, similarly, may be considered the differential growth by a plant in response to gravity pulling on the plant 402. A plant's root system may grow in the direction of the gravitational force (i.e., downward) while the body of the plant 402 may grow opposite (differentially) to the gravitational pull.

In a conventional vertical grow configuration 400 with distanced light sources 406, a plant may grow in directions outward and upward due to the phototropism and gravitropism. For example, the growth direction of the plant 402 may be shown by arrow 474 as a combination of a phototropic force 470 and a gravitropic force 472. Not only does such growth occupy more space, due to the plant 402 growing toward the light source 406, the weight of the plant 402, including its stem 414, leaves, fruit, seeds or the like, the structure of the plant 402 may be weaker, necessitating the use of netting or other structures to help support the plant and isolate it from the other plants in the structure 404.

Conversely, the inverse lighting configuration 450 may reverse the phototropic force such that the plant 452 may grow upward and back toward the structure 454 because of the disposition of the light source 456 on or adjacent to the structure 454. The light 458 emitted from the light source 456 may cause the plant 452 to grow in closer proximity to the structure 454. The light source 456 may include LED lamps, incandescent or fluorescent lamps, infrared lamps, or other suitable photosynthetic energy source. The growth direction of the plant 402 may be shown by arrow 476 as a combination of a phototropic force 470 and a gravitropic force 472, toward the structure 454 and upward. The closer proximity to the light source 456 and the increased verticality of the plant 452 and its stem 464 may provide for a stronger plant structure and eliminate the need for netting or other supports.

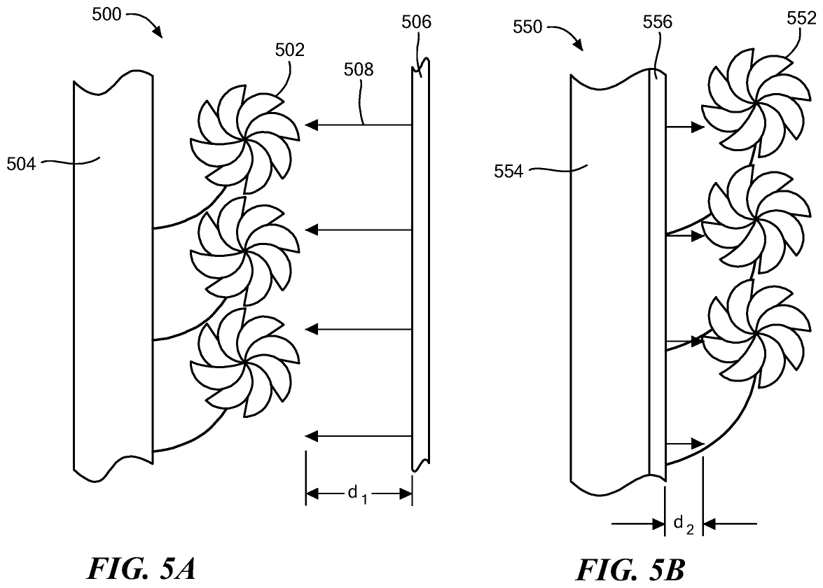

According to another aspect of the present disclosure, the inverse lighting configuration may reduce energy costs required to produce a strong crop yield. FIGS. 5A-5B show a lighting comparison between a conventional lighting configuration 500 (FIG. 5A) and an inverse lighting configuration 550 (FIG. 5B). According to one aspect, the intensity of a light source 506, 556 for plant growth may be given as

$$I = \frac{P}{4 π {d}^{2}} ,$$

where P is power (watts), and d is the distance from the plant 502, 552 to the light source 506, 556.

As one example, the conventional lighting configuration 500 may include a structure 504 and a light source 506 emitting light 508 on the plants 502 from a distance. The light source 506 may include LED lamps, incandescent or fluorescent lamps, infrared lamps, or other suitable photosynthetic energy source.

As an illustrative example, if the light source 506 is disposed at a distance d₁=0.3 m (about 12 in.), and a desired light intensity is about 857 W/m², the light source 506 must provide about 1000 W of power. On the other hand, in the inverse lighting configuration 550, with a structure 554 and an adjacent light source 556, if the plants 552 are at a distance d₂=0.05 m (about 2 in.), and the same light intensity of about 857 W/m² is desired, the light source 556 must provide about 29 W of power, a reduction in power required to produce the same intensity. The light source 556 may include LED lamps, incandescent or fluorescent lamps, infrared lamps, or other suitable photosynthetic energy source. The inverse lighting configuration 550 may be advantageous over the conventional lighting configuration 500 by allowing plants 552 to be grown with significantly less electricity (and heat) without affecting the optimal intensity for photosynthesis.

While the example above relies on a particular desired light intensity, one skilled in the art will recognize that the aspects of the present disclosure are not limited to the particular example, and that any desired light intensity may be used, depending on the plant, grow environment, or the like.

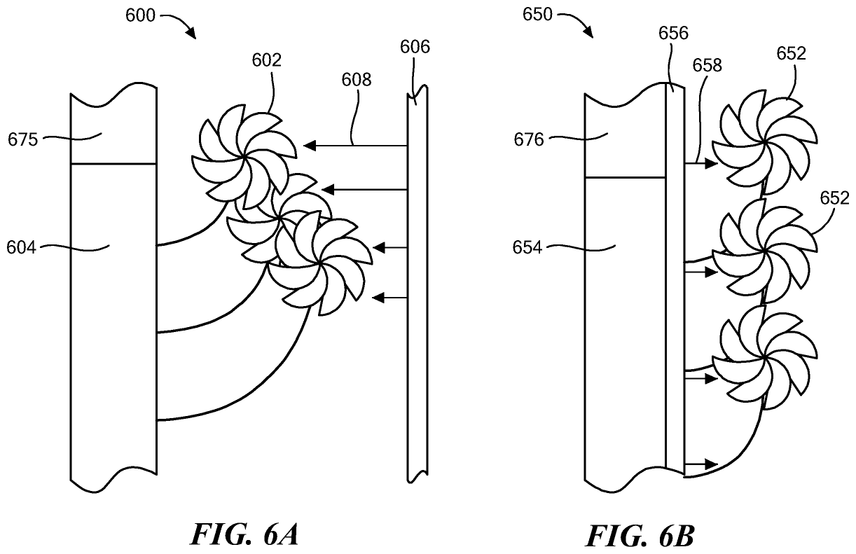

According to another aspect of the disclosure, the inverse lighting configuration may expose a larger area of each individual plant to light energy because the plants and their canopies may be more efficiently spaced. FIGS. 6A-6B show a comparison of a conventional lighting configuration 600 plant spacing versus an inverse lighting configuration 650 plant spacing. In a conventional configuration 600, a structure 604 (fed by an irrigation system 675) may hold one or more plants 602. The irrigation system 675 may include one or more manifolds, reservoirs, pumps, and pipes or plumbing establishing fluid communication therethrough. The light energy 608 from the light source 606 may not be directly incident on the entirety of the plants because the plants 602 may form a canopy with overlapping leaves, causing the plants 602 compete with neighboring plants 602 for light energy 608. The light source 606 may include LED lamps, incandescent or fluorescent lamps, infrared lamps, or other suitable photosynthetic energy source.

In an inverse lighting configuration 650, however, the plants 652 disposed in the structure 654 and fed by irrigation system 676 may grow in response to the light energy 658 provided by the light source 656 adjacent to the structure 654 such that plants 652 are not overlapping and are free to grow without competing for incident light energy 658. The light source 656 may include LED lamps, incandescent or fluorescent lamps, infrared lamps, or other suitable photosynthetic energy source. The irrigation system 676 may include one or more manifolds, reservoirs, pumps, and pipes or plumbing establishing fluid communication therethrough.

The phototropic and gravitropic forces may cause the plants 652 to grow in a more vertical direction (as opposed to a horizontal direction), allowing more of the plants' 652 surface area to receive the light energy 658 from the light source 656 without competing for light and space.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A multi-plant holder comprising:
a structure defining a plurality of holders adapted to retain a plurality of plants; and
a light source disposed adjacent to the structure;
wherein the light source is adapted to provide a positive phototropic force on the plurality of plants towards the structure.

2. The multi-plant holder of claim 1 wherein the light source is adapted to emit energy away from the structure.

3. The multi-plant holder of claim 1 wherein the each of the plurality of holders is aligned vertically in the structure.

4. The multi-plant holder of claim 1 wherein the structure is a tower.

5. The multi-plant holder of claim 4 wherein the tower defines a central column in fluid communication with the plurality of holders.

6. The multi-plant holder of claim 1 wherein the structure comprises a plurality of towers, each of the plurality of towers defining a vertical arrangement of holders.

7. The multi-plant holder of claim 1 wherein the light source is adapted to provide the positive phototropic force towards a top portion of the structure.

8. The multi-plant holder of claim 1 wherein the plurality of holders are defined on a first side and a second side of the structure.

9. The multi-plant holder of claim 8 wherein the light source is coupled to the first side and the second side of the structure.

10. The multi-plant holder of claim 1 where in the structure is in fluid communication with an irrigation system adapted to supply a nutrient to the plurality of holders.

11. A method of cultivating a plant, the method comprising:
disposing a plurality of plants into a plurality of holders defined in a structure; and
disposing a light source adjacent to the structure, wherein the light source is adapted to provide a positive phototropic force on the plurality of plants towards the structure.

12. The method of claim 11 wherein the light source is adapted to emit energy away from the structure.

13. The method of claim 11 wherein the each of the plurality of holders is aligned vertically in the structure.

14. The method of claim 11 wherein the structure is a tower.

15. The method of claim 14 wherein the tower defines a central column in fluid communication with the plurality of holders.

16. The method of claim 11 wherein the structure comprises a plurality of towers, each of the plurality of towers defining a vertical arrangement of holders.

17. The method of claim 11 wherein the light source is adapted to provide the positive phototropic force towards a top portion of the structure.

18. The method of claim 11 wherein the plurality of holders are defined on a first side and a second side of the structure.

19. The method of claim 18 wherein the light source is coupled to the first side and the second side of the structure.

20. A multi-plant holder comprising:
a structure having a first side and second side, each side defining a plurality of vertically spaced holders, each of the vertically spaced holders defining a recess adapted to receive a plant;
an irrigation system in fluid communication with the structure and the plurality of vertically spaced holders; and
a first light source adjacent to the first side and a second light source adjacent to the second side;
wherein the first light source and the second light source are adapted to provide a positive phototropic force towards the structure.
